(19) United States
(12) Patent Application Publication
(10) Pub. No.: US 2005/0109136 A1
(43) Pub. Date: May 26, 2005

(54) Starter for internal combustion engine

(75) Inventors: Sadayoshi Kajino, Nagoya-city (JP); Youichi Hasegawa, Kasugai-city (JP); Tomoya Imanishi, Kariya-city (JP); Yasuo Osawa, Nitta-gun (JP)

Correspondence Address: OLIFF & BERRIDGE, PLC, P.O. BOX 19928, ALEXANDRIA, VA, 22320, US

(73) Assignees: Denso Corporation, Kariya-city (JP); Sawafuji Electric Co., Ltd., Tokyo (JP)

(21) Appl. No.: 11/027,940

(22) Filed: Jan. 4, 2005

Related U.S. Application Data
(63) Continuation of application No. 10/407,194, filed on Apr. 7, 2003.

(30) Foreign Application Priority Data
Apr. 26, 2002 (JP) 2002-127070

(51) Int. Cl. F02N 11/00

(52) U.S. Cl. 74/6

(57) ABSTRACT

A starter for an internal combustion engine includes a motor, a pinion gear connected to the motor to be engaged with a ring gear of the engine. The pinion gear has teeth of a negative addendum modification whose number is larger than a standard gear that has the same outside diameter. Therefore the gear ratio of the pinion gear to the ring gear can be increased without change of the outside diameter thereof.

### CROSS REFERENCE TO RELATED APPLICATION

The present application is based on and claims priority from Japanese Patent Application 2002-127070 filed Apr. 26, 2002, the contents of which are incorporated herein by reference.

### BACKGROUND OF THE INVENTION

1. Field of the Invention

The present invention relates to a starter for an internal combustion engine and, particularly, a starter having a pinion to be engaged with a ring gear of an internal combustion engine.

2. Description of the Related Art

A speed reduction type starter that includes a pinion and a speed reduction mechanism has been widely used for an internal combustion engine. Such a speed reduction type starter employs a high-speed motor so that the size can be as small as possible.

As shown in FIG. 6, when the output torque of a speed reduction type starter is in a comparatively smaller range, the rotation speed of the pinion lowers as the speed reduction ratio becomes larger. In other words, the pinion of a starter that has a larger speed reduction ratio rotates at a lower rotation speed than the pinion of a starter that has a smaller speed reduction ratio.

Therefore, starting performance of the starter of a comparatively larger speed reduction ratio is not as good as the starting performance of the starter of a comparatively smaller speed reduction ratio. In order to increase the cranking speed of the engine, the number of the gear of the pinion should be increased so that the gear ratio of the pinion gear to the ring gear can be increased. Because it is very difficult to change the ring gear, the number of the pinion gear's teeth has to be increased to increase the gear ratio. In general, as the number of the pinion gear teeth is increased, the outside diameter of the pinion increases, resulting in increase in the center pitch Cp between the center of the pinion gear and the center of the ring gear. If the center pitch Cp increases, it is very difficult to mount the starter on the engine. That is, location of the mounting bracket of the starter housing to be mounted on an engine have to be changed. For example, if the diametral pitch DP is 6, the mounting bracket must be shifted from the center axis of the pinion gear by about 2.1 mm each tooth to be increased.

### SUMMARY OF THE INVENTION

Therefore, a main object of the invention is to provide a starter for an internal combustion engine that has an improved pinion gear. The improved pinion gear has an increased number of gear teeth although the outside diameter is not increased, so that the center pitch between the ring gear and the pinion gear is not increased.

According to a feature of the invention, a starter for an internal combustion engine includes a motor, a pinion gear connected to the motor to be engaged with the ring gear of the engine, and the pinion gear has teeth of a negative addendum modification whose number is larger than a standard gear that has the same outside diameter. Therefore, when the engine is rotated by the starter, the rotation speed is high enough for the engine to be started. The pinion gear of the above starter may have one more tooth than a standard pinion gear that has the same outside diameter.

Preferably, the number of the teeth 12, while the number of the teeth of the corresponding standard pinion gear is 11. The starter has mounting flange having a plurality of mounting holes, which are formed at a circle that has the center where the rotation center of the pinion gear is located.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1A is a plan view of an improved pinion gear of a starter for an internal combustion engine according to a preferred embodiment of the invention, and FIG. 1B is a plan view of a common pinion gear;

FIG. 2 is a schematic diagram comparing the improved pinion gear and the common pinion gear in engagement with a ring gear of an engine;

FIG. 3 is a side and partially cross-sectional view of the starter according to the preferred embodiment;

FIG. 4 is a front view of the starter according to the preferred embodiment;

FIG. 5 is a schematic diagram graph comparing the improved pinion gear and other pinion gears; and

FIG. 6 is a graph comparing characteristics of two starters having speed reduction mechanisms the speed reduction ratio of which is different from each other.

### DETAILED DESCRIPTION OF THE PREFERRED EMBODIMENTS

A starter for an internal combustion engine includes a motor 2, a pinion gear 3, a planetary gear speed reduction mechanism 4, an electromagnetic switch 5, an end bracket 12, a center case 13, a motor yoke 14 and a housing 15. The motor is a DC motor that includes an armature 6. When a motor switch (not shown) is closed, the motor 2 is supplied with current from a battery to rotate the armature 6. The electromagnetic switch 5 has a solenoid and a plunger (not shown) which opens the motor switch when driven by the solenoid.

The speed reduction mechanism 4, which includes a planetary gears 7 and a sun gear, reduces the rotation speed of the motor 2 by the planetary gears 7 revolving around the sun gear and provides a speed-reduced rotation at the output shaft 8. The output shaft 8 carries a one-way clutch 9 and the pinion gear 3.

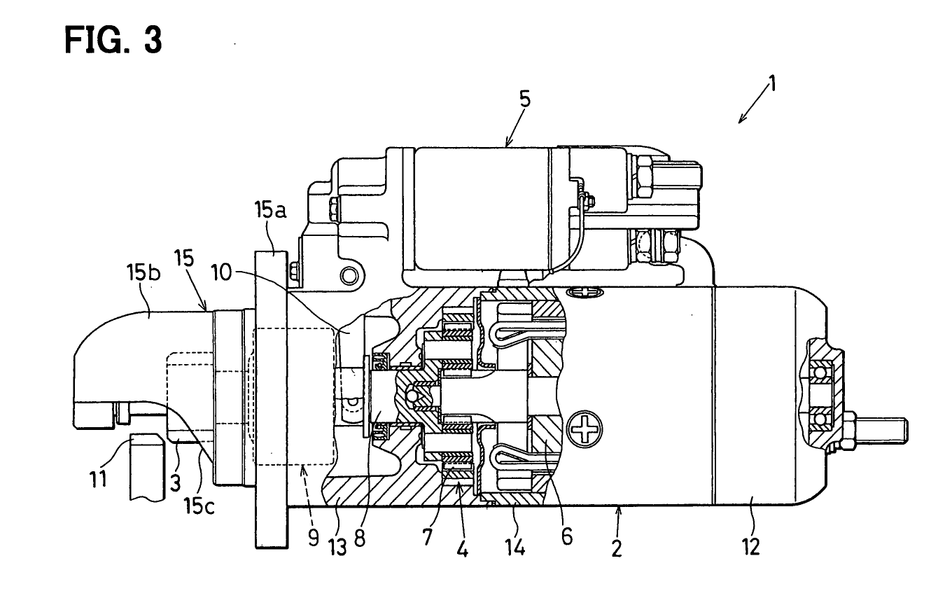

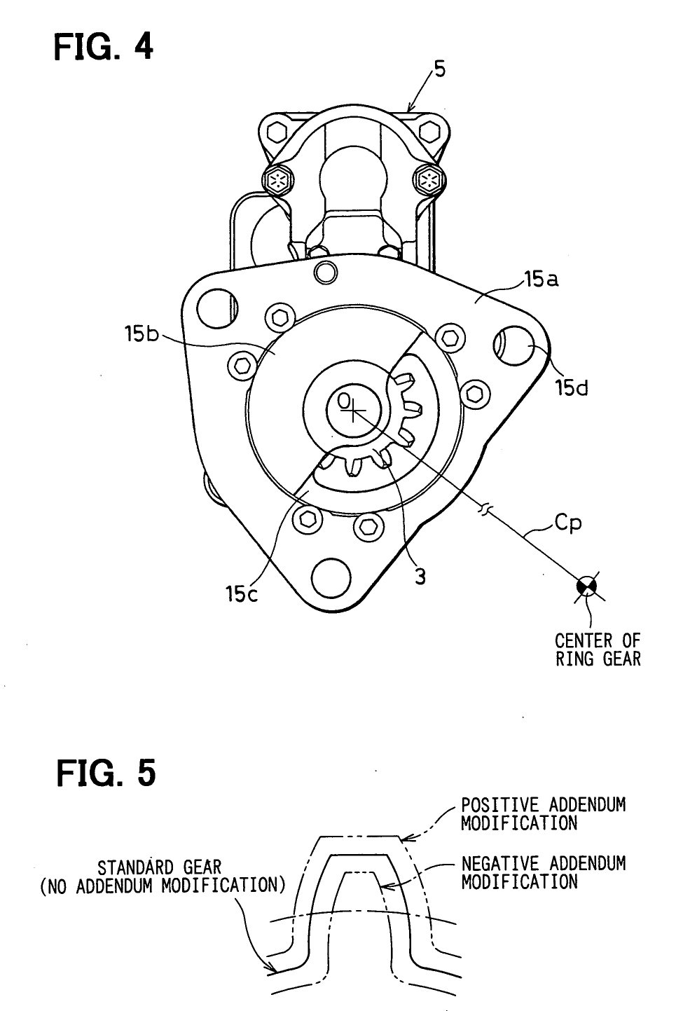

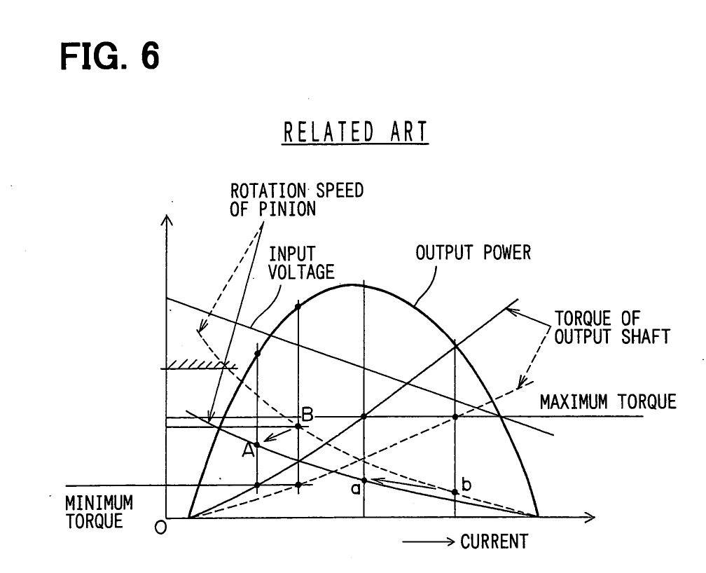

The one-way clutch 9 is a typical roller type clutch that is ordinarily used for a starter. The one-way clutch 9 is connected to the electromagnetic clutch 5 via a lever 10 and to the output shaft 8 via a helical spline connection formed between inside surface of the one-way clutch 9 and outer periphery of the output shaft so that the one-way clutch 9 can axially move along the output shaft 8. When an engine is started, the pinion gear 3 together with the one-way clutch 9 is driven by the electromagnetic switch 5 to move leftward in FIG. 3 along the output shaft 8. Then, the pinion gear 3 engages a ring gear 11 of the engine so that the motor 2 rotates or cranks the engine via the one-way clutch 9.

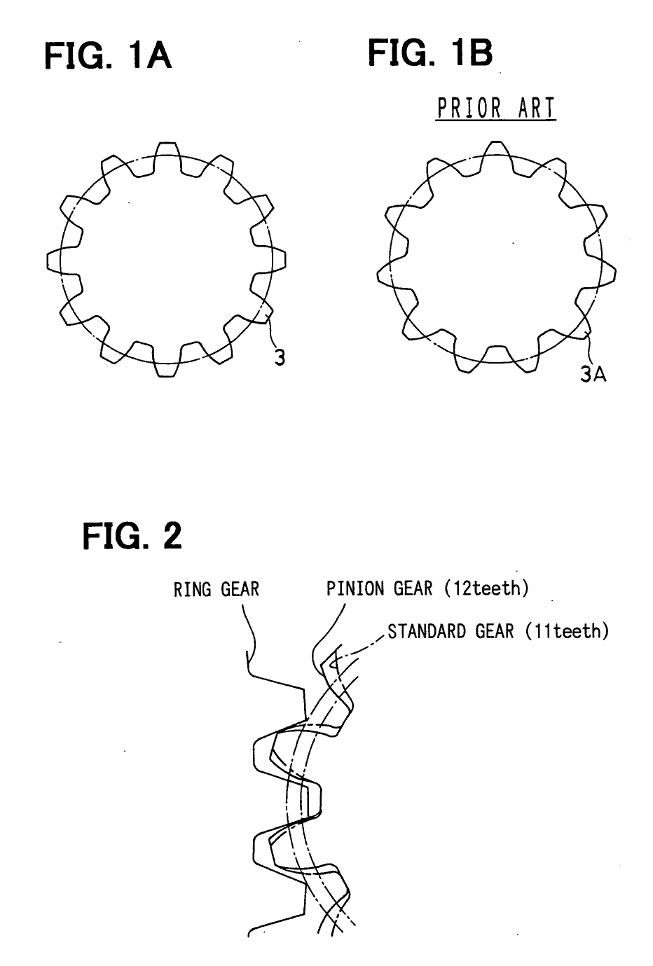

As shown in FIG. 1A, the improved pinion gear 3 has twelve teeth, which has one tooth more than a common pinion gear 3A, shown in FIG. 1B, whose teeth are formed to have a positive addendum modification, as shown in FIG. 5. While the improved pinion gear 3 shown in FIG. 1A has the same outside diameter and diametral pitch (e.g. DP=6) as the common pinion gear 3A shown in FIG. 1B. Therefore, the improved pinion gear 3 can be formed from the same piece of material as the common pinion gear 3A. That is, the 12 teeth are formed to have a negative addendum modification, as shown in FIG. 5, so that the center pitch Cp or the distance between center of the ring gear and the center of the pinion gear 3 is not increased. Incidentally, the addendum modification Am is an amount of change in tooth depth that is expressed as follows:
Am=x·M
where x is a addendum modification coefficient, and M is a module.

The motor yoke 14 is disposed between the end bracket 12 and the center case 13 and fixed to the housing 15 by a plurality of through bolts (not shown) inserted from the side of the end bracket 12. The housing 15 is composed of a flange 15a by which the starter 1 is fixed to the engine and a nose portion 15b which covers the pinion gear 3.

The nose portion 15b has an opening 15c through which the pinion gear 3 engages the ring gear 11 of the engine. The flange 15a has three mounting holes 15d through which fastening blots extend to fix the flange 15a to the engine. The mounting holes 15d are formed at a circle that has the center where the rotation center or axis O of the pinion gear 3 is located. Therefore, the center pitch Cp between the pinion gear 3 and the ring gear 11 is not different from a commonly used starter that has 11-teeth pinion gear.

Thus, the starter 1 having 12-teeth pinion gear 3 can be mounted on the same position of the engine as a starter having 11-teeth pinion gear with no-change except the pinion gear. A starter having 13 or more teeth, which can be mounted on an engine without change, can be also provided in the same manner as described above.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

1. A method of changing rotation speed of a starter that includes a motor and a pinion gear have a prescribed number of teeth and a prescribed outside diameter and a diametral pitch,
wherein the number of teeth of said pinion gear is increased without changing the outside diameter and the diametral pitch.

2. The method as claimed in claim 1,
wherein the prescribed number of teeth this 11, which is increased to 12.

3. The method as claimed in claim 1,
wherein said starter comprises a housing having a mounting bracket, and
said flange has a plurality of mounting holes disposed coaxially with the rotation center of said pinion gear.

4. The method as claimed in claim 1,
said starter further comprises a speed reduction mechanism connected between said motor and said pinion gear.
